(19) United States
(12) Patent Application Publication
(10) Pub. No.: US 2008/0064397 A1
(43) Pub. Date: Mar. 13, 2008

(54) APPARATUS AND METHOD FOR RESELECTING CELL IN PORTABLE TERMINAL

(75) Inventors: Sang-Joon PARK, Anyang-si (KR); Jae-Kyun Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/854,441

(22) Filed: Sep. 12, 2007

(30) Foreign Application Priority Data
Sep. 13, 2006 (KR) 2006-0088464

(51) Int. Cl. H04Q 7/22

(52) U.S. Cl. 455/434

(57) ABSTRACT

An apparatus and a method of a portable terminal using a high speed downlink packet data service, for reselecting a cell that supports HSDPA, are provided, which include a communication unit for receiving a broadcast message, a broadcast message reading unit for determining whether there is a cell which supports the HSDPA service by reading the received broadcast message, and sending the result to the control unit, and the control unit for controlling the communication unit and the broadcast message reading unit.

### PRIORITY

This application claims priority under 35 U.S.C. §119 to an application filed in the Korean Intellectual Property Office on Sep. 13, 2006 and assigned Serial No. 2006-88464, the contents of which are incorporated herein by reference.

### BACKGROUND OF THE INVENTION

1. Field of the Invention

The present invention relates generally to a portable terminal that supports a High Speed Downlink Packet Access (HSDPA), and in particular, to an apparatus and method for reselecting a cell that supports HSDPA by a portable terminal using a high speed downlink packet data service.

2. Description of the Related Art

The Universal Mobile Telecommunication System (UMTS) is a Third Generation (3G) mobile communication system that evolved from the European standard, Global System for Mobile Communications (GSM), and aims to provide improved mobile communication service based on the GSM core network combined with Wideband Code Division Multiple Access (WCDMA) technology.

UMTS has been commercialized in many countries. Subscribers increase and 3rd Generation Partnership Projection (3GPP) is working on the standardization of UMTS. Compared to the existing 2nd-Generation (2G) system, UMTS provides high speed data and multimedia service, and as it is expected to be used worldwide, a global roaming function can be provided.

The currently commercialized R99/R4 UMTS supports data transmission speed up to 64 kbps in the uplink connection, and up to 384 kbps in the downlink connection. Comparatively, the UMTS R5 standard has now developed the HSDPA technology, which provides data transmission up to 14 Mbps in the downlink connection.

HSDPA provides improved radio interface capacity in a wireless system, to support the high data rate service such as web browsing and multi-media, and it uses the downlink shared channel which is used in the asynchronous mobile communication system. HSDPA is currently being considered as a technology for providing high rate data services such as Internet and motion picture service.

HSDPA not only provides the fast data packet service, but also provides the fast service of converting voice data into Internet Protocol (IP) packets and providing the voice data as IP packets.

A portable terminal using the HSDPA service performs a cell reselection to handover from a current cell to a cell with a better reception signal so as to provide better service to a user.

Handover to a cell with a better reception signal is generally based on the information received from a base station, and in particular, the result of a comparison between the received signals.

That is, a portable terminal hands off to another cell in the neighborhood, if it is determined that the cell has a reception signal of greater intensity than the current cell in which the portable terminal is deployed.

The shortcoming of the cell reselection derives from the fact that it only depends on the intensity of the reception signals of the neighboring cells to determine a next cell. Accordingly, the reselection process can select a cell that does not support the HSDPA service. That is, a portable terminal may discover a neighboring cell having a reception signal of greater intensity, reselect the cell and attempt the HSDPA service, only to discover that the selected neighboring cell does not support the HSDPA service.

Therefore, an apparatus and method of a portable terminal which supports the HSDPA service is required, which determines the intensity of the reception signals and whether the neighboring cell supports the HSDPA service, and gives priority to a cell that supports the HSDPA service.

### SUMMARY OF THE INVENTION

An aspect of the present invention is to substantially solve at least the above problems and/or disadvantages and to provide at least the described advantages set forth below. Accordingly, an aspect of the present invention is to provide an apparatus and method of a portable terminal for reselecting a cell that supports the HSDPA service among neighboring cells.

Another aspect of the present invention is to provide an apparatus and method of a portable terminal for reading a broadcast message that includes the information as to whether the HSDPA service is available.

According to the present invention, there is provided an apparatus for determining a cell which supports an HSDPA, which includes a communication unit for receiving a broadcast message, a broadcast message reading unit for, according to instruction of a control unit, determining whether or not there is a cell which supports the HSDPA service by reading the received broadcast message, and providing the control unit with the result of determination, and the control unit for controlling the communication unit and the broadcast message reading unit.

According to the present invention, there is provided a method of cell reselection of a portable terminal which determines a cell which supports an HSDPA, which includes receiving a broadcast message from a base station, determining neighboring cells available for cell reselection by reading the received broadcast message, and performing cell reselection with respect to a cell which supports the HSDPA service, among the cells available for cell reselection.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the structure of a 3^{rd} Generation Partnership Project UTMA Terrestrial Radio Access Network (3GPP UTRAN) according to the present invention;

FIG. 2 illustrates the structure of a portable terminal for determining whether the HSDPA service is supported based on broadcast information according to the present invention; and

FIG. 3 illustrates the process of a portable terminal, reading a broadcast message and performing a cell reselection of a neighboring cell that supports the HSDPA service according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

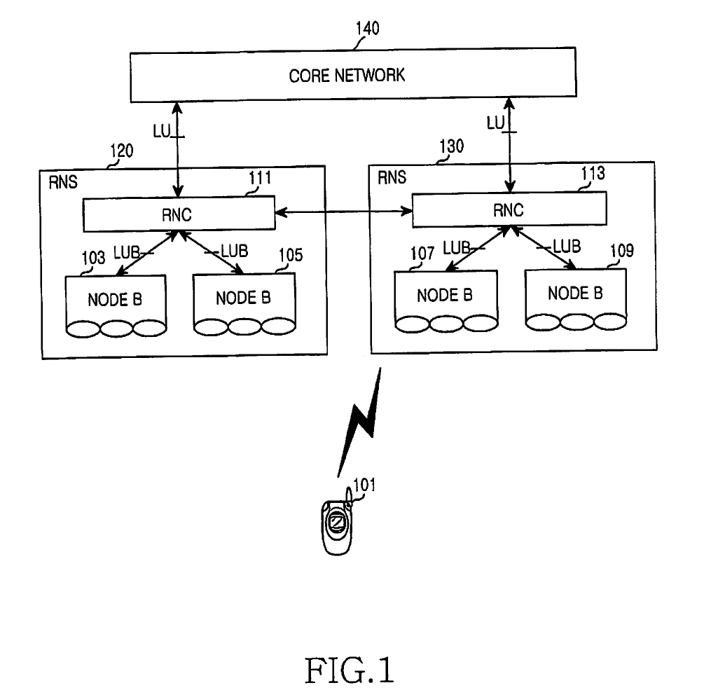

FIG. 1 illustrates the structure of a 3GPP UTRAN according to the present invention.

Referring to FIG. 1, the UTRAN includes one or more Radio Network Sub-systems (RNS) 120, 130, each including one Radio Network Controller (RNC) 111, 113, and one or more base stations (node B) 103, 105, 107 and 109 each controlled by one of the RNCs 111, 113. Each RNC 111, 113 is connected to a core network 140 for circuit switching and packet switching communications.

A portable terminal 101 radio communicates with and transmits and receives data to and from the nodes B 103, 105, 107 and 109. According to an aspect of the present invention, the portable terminal 101 also receives a broadcast message from the RNCs 111, 113 and determines whether or not the HSDPA service is supported in the neighboring cells available for the cell reselection. If it determines that one of the neighboring cells available for the cell reselection supports the HSDPA service, the portable terminal 101 performs the cell reselection of the neighboring cell that supports the HSDPA service.

Each of the nodes B 103, 105, 107 and 109 is controlled by one of the RNCs 111, 113, and operates to receive information sent from the physical layer of the portable terminal 101 in an uplink connection, and transmits data to the portable terminal in a downlink connection. In other words, the nodes B 103, 105, 107, 109 may serve as an Access Point (AP) of the UTRAN with respect to the portable terminal 101. The nodes B 103, 105, 107 and 109 broadcast a message to the portable terminal 101 periodically, through a broadcast control channel, to transmit information about neighboring nodes B. According to an aspect of the present invention, the broadcast message sent to the portable terminal 101 may include information about whether the cells support HSDPA service.

The portable terminal 101 reads the broadcast message, and uses the read broadcast message in selecting and reselecting cells.

The RNCs 111, 113 handle allocation and management of radio resources. Among the RNCs 111, 113, a control RNC handles direct management of the nodes B 103, 105, 107 and 109, and management of shared radio resources, and a serving RNC handles management of dedicated radio resources allocated to each portable terminal 101.

An interface is necessary, to connect a variety of different elements in the UMTS network, because these elements may have varying physical locations. The nodes B 103, 105, 107 and 109 and the RNCs 111, 113 are connected via an lub interface, the RNCs 111, 113 are connected with each other via an lur interface, and the RNCs 111, 113 and the core network 140 are connected via an lu interface.

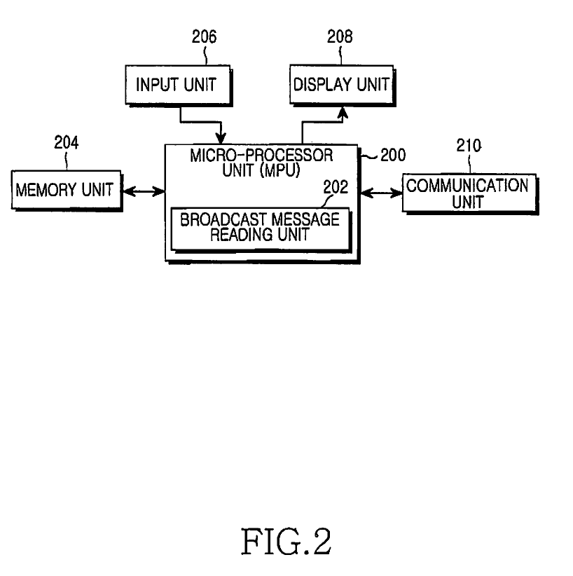

FIG. 2 illustrates the structure of a portable terminal for determining whether the HSDPA service is supported based on broadcast information according to the present invention.

Referring to FIG. 2, the portable terminal 101 includes a Micro-Processor Unit (MPU) 200, a memory unit 204, an input unit 206, a display unit 208 and a communication unit 210. The control unit 200 may include a broadcast message reading unit 202.

The MPU 200 controls the overall operation of the portable terminal 101. For example, the MPU 200 may handle processing and controlling for voice telephony and data communication, and according to an aspect of the present invention, direct such that when a broadcast message is received, the broadcast message reading unit 202 reads the received broadcast message, determines whether there is a neighboring cell that meets the requirements for cell reselection, and determines whether the neighboring cell supports the HSDPA service.

That is, the MPU 200 directs to determine whether the cell supports the HSDPA service, so that cell reselection can be made among the HSDPA-supporting cells.

The broadcast message reading unit 202, according to the instruction from the MPU 200, interprets the received broadcast message and acquires cell information included in the broadcast message. The cell information may include the intensities of reception signals at respective cells, and information as to whether the cells support the HSDPA service.

The broadcast message reading unit 202 provides the MPU 200 with the acquired cell information.

The memory unit 204 includes a Read Only Memory (ROM) and a Random Access Memory (RAM). The ROM stores therein micro codes of the programs for processing and controlling of the MPU 200, and also stores the programs for operating the MPU 200 or the broadcast message reading unit 202.

The RAM operates as a working memory of the MPU 200, and stores therein temporary data generated during the execution of the programs.

The input unit 206 includes number buttons 0 to 9, and a variety of function keys including a menu button (Menu), a cancel button (Delete), a confirm button, a talk button (Talk) and an end button (End), an Internet access button, a navigation key and a text input key, and provides the MPU 200 with the key input data corresponding to the keys pressed by the user.

The display unit 208 displays status information generated during the operation of the portable terminal 101, a limited number of text characters and a large volume of motion and still pictures. The display unit 208 may be implemented as a color Liquid Crystal Display (LCD).

The communication unit 210 operates to transmit and receive a radio signal of data being input and output over an antenna. For example, in a transmission, the communication unit 210 may perform channel coding, spreading, and Radio Frequency (RF) processing of the data to be transmitted and transmit the data, while in a reception, the communication unit 210 may perform converting of a received RF signal into a baseband signal, and restoring the received data by de-spreading and channel decoding. According to an aspect of the present invention, the communication unit 210 also receives a broadcast message from the nodes B 103, 105, 107 and 109, which indicates whether the HSDPA service is supported.

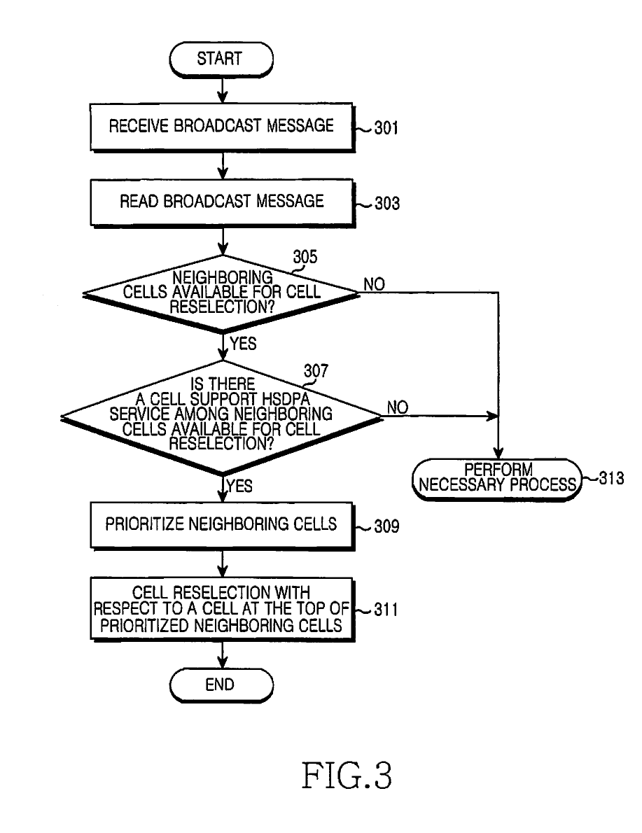

FIG. 3 illustrates the process of a portable terminal, reading a broadcast message and performing a cell reselection of a neighboring cell that supports the HSDPA service according to the present invention.

Referring to FIG. 3, in step 301, the MPU 200 of the portable terminal 101 receives a broadcast message from the nodes B 103, 105, 107 and 109 via the communication unit 210. It is assumed that the portable terminal 101 is in an idle state.

The broadcast cast transmitted from the nodes B 103, 105, 107 and 109 may include a System Information Block (SIB) received at the 3G mobile communication service cells, and it refers to system information 3/11 (SYSTEM_INFORMATION_{—}3/11) which is used when the portable terminal is in the idle state. The system information 3 includes information about the current cell in which the portable terminal 101 is deployed, and the system information 11 includes information about the neighboring cells to the portable terminal 101.

The system information block may include information indicative of intensities of reception signals at a cell in which the portable terminal 101 is currently deployed and the neighboring cells. Since an additional field which indicates whether the cells support the HSDPA service as shown in Table 1 below, the portable terminal 101 can determine the cell that supports the HSDPA service, upon receipt of the system information block.

TABLE 1

| Information | | |
|---|---|---|
| Element/Group name | Need | Type |
| HSDPA Indicator | OP | 0 = HSDPA service unavailable |
| | | 1 = HSDPA service available |

HSDPA Indicator informs whether the cell supports the HSDPA service. For example, HSDPA Indicator Type ‘0’ indicates that the cell does not support the HSDPA service, and HSDPA Indicator Type ‘1’ indicates that the cell supports the HSDPA service.

In step 303, the MPU 200 instructs the broadcast message reading unit 202 to read the received broadcast message, and in step 305, determines whether there is a neighboring cell available for cell reselection. Upon receipt of instruction from the MPU 200, the broadcast message reading unit 202 checks the intensities of reception signals of the cells contained in the received broadcast message, and provides the MPU 200 with the information as to whether there is a neighboring cell available for cell reselection.

That is, the portable terminal 101 investigates whether there is a neighboring cell that has a greater intensity of reception signal than the current cell.

If it is determined that there is no neighboring cell available for cell reselection, in step 313, the MPU 200 performs an appropriate process, such as deferring cell reselection and retaining the current cell.

If it is determined that there is a neighboring cell available for cell reselection, in step 307, the MPU 200 instructs the broadcast message reading unit 202 to investigate whether there is any cell among the available neighboring cells that supports the HSDPA service. This may be determined based on the HSDPA service indicator which is included in the system information block.

If it is determined that none of the available neighboring cells supports the HSDPA service, that is, if HSDPA Indicator=0, in step 313, the MPU 200 performs an appropriate process, such as selecting a cell having the largest intensity of reception signal.

If it is determined that there is a neighboring cell that supports the HSDPA service, that is, if HSDPA Indicator=1, in step 309, the MPU 200 determines the priority of the neighboring cell. The neighboring cells that support the HSDPA service are prioritized, according to their suitability to be selected as a next cell in the cell reselection.

For example, the neighboring cells that support the HSDPA service may be prioritized, in the order of greater intensity of the reception signal.

In step 311, the MPU 200 selects the cell at the top of the prioritized neighboring cells, and ends the algorithm according to the present invention.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As explained above, because information indicative of whether the HSDPA service is supported is included in a broadcast message sent from the base station, and the portable terminal reads the broadcast message upon receipt and accordingly performs cell reselection among the cells that support the HSDPA service, selection of a cell which does not support the HSDPA service is prevented.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for determining a cell which supports a High Speed Downlink Packet Access (HSDPA) service, comprising:
a communication unit for receiving a broadcast message;
a broadcast message reading unit for, according to instruction of a control unit, determining whether there is a cell which supports the HSDPA service by reading the received broadcast message, and providing the control unit with a result of the determination; and
the control unit for controlling the communication unit and the broadcast message reading unit.

2. The apparatus of claim 1, wherein the control unit instructs the broadcast message reading unit to read the broadcast message received through the communication unit, and to determine whether there is a cell which supports the HSDPA service among cells available for cell reselection.

3. The apparatus of claim 2, wherein the control unit controls such that a cell which best meets requirements of cell reselection is selected, among the cells which are determined to support the HSDPA service by the broadcast message reading unit.

4. The apparatus of claim 3, wherein the broadcast message further comprises a System Information Block (SIB) which includes intensities of reception signals of neighboring cells to a cell at which the portable terminal is deployed, and information indicating whether the HSDPA service is supported.

5. A method of cell reselection of a portable terminal which determines a cell that supports a High Speed Downlink Packet Access (HSDPA) service, the method comprising:
receiving a broadcast message from a base station;
determining neighboring cells available for cell reselection by reading the received broadcast message; and
performing cell reselection with respect to a cell that supports the HSDPA service, among the cells available for the cell reselection.

6. The method of claim 5, wherein the performing cell reselection further comprises:
prioritizing neighboring cells; and
selecting a cell which supports the HSDPA service, among the prioritized neighboring cells.

7. The method of claim 5, further comprising selecting a cell, which supports the HSDPA service, before performing the cell reselection with respect to the selected cell.

8. The method of claim 6, wherein the neighboring cells available for cell reselection are prioritized in an order to a greater intensity of reception signal.

9. The method of claim 5, wherein the broadcast message further comprises a System Information Block (SIB) which includes intensities of reception signals of neighboring cells to a cell at which the portable terminal is deployed, and information indicating whether the HSDPA service is supported.

10. A portable terminal for determining a cell which supports a High Speed Downlink Packet Access (HSDPA) service, comprising:
means for determining whether there is a cell which supports the HSDPA service by reading the received broadcast message.

11. The portable terminal of claim 10, further comprising means for performing cell reselection with respect to the cell that supports the HSDPA service.

12. The portable terminal of claim 10, wherein the broadcast message further comprises a System Information Block (SIB) which includes intensities of reception signals of neighboring cells to a cell at which the portable terminal is deployed, and information indicating whether the HSDPA service is supported.

13. A method of determining a cell which supports a High Speed Downlink Packet Access (HSDPA) in a mobile communication system, comprising:
receiving a broadcast message from a base station;
determining neighboring cells available for cell reselection by reading the received broadcast message; and
performing cell reselection with respect to a cell that supports the HSDPA service, among the cells available for the cell reselection.

14. The method of claim 13, wherein the performing cell reselection further comprises:
prioritizing neighboring cells; and
selecting a cell which supports the HSDPA service, among the prioritized neighboring cells.

15. The method of claim 13, further comprising selecting a cell, which supports the HSDPA service, before performing the cell reselection with respect to the selected cell.

16. The method of claim 14, wherein the neighboring cells available for cell reselection are prioritized in an order to a greater intensity of reception signal.

17. The method of claim 13, wherein the broadcast message further comprises a System Information Block (SIB) which includes intensities of reception signals of neighboring cells to a cell at which the portable terminal is deployed, and information indicating whether the HSDPA service is supported.

18. A computer-readable recording medium having recorded thereon a program cell reselection of a portable terminal which determines a cell that supports a High Speed Downlink Packet Access (HSDPA), comprising:
a first segment, for receiving a broadcast message from a base station;
a second segment, for determining neighboring cells available for cell reselection by reading the received broadcast message; and
a third segment, for performing cell reselection with respect to a cell that supports the HSDPA service, among the cells available for the cell reselection.
